(19) United States
(12) Patent Application Publication
(10) Pub. No.: US 2018/0096490 A1
(43) Pub. Date: Apr. 5, 2018

(54) METHOD FOR DETERMINING ANTHROPOMETRIC MEASUREMENTS OF PERSON

(71) Applicant: Aarila Dots Oy, Pori (FI)

(72) Inventor: JONI JUVONEN, Turku (FI)

(21) Appl. No.: 15/282,205

(22) Filed: Sep. 30, 2016

(51) Int. Cl. G06T 7/60

(52) U.S. Cl. CPC G06T 7/60; H04N 5/225

(57) ABSTRACT

A method for determining anthropometric measurements of a person includes receiving at least two images of the person standing in front of a background, using a camera of a device, receiving at least two images of the background using the camera, receiving at least one imaging factor associated with the camera, computing a statistical background model for the received images of the background, creating a person probability map, determining edges of the person, determining measurement points using the edges of the person and the person probability map, performing perspective correction for the received images of the person and/or the images of the background using a pitch angle of the device and the at least one imaging factor, receiving information related to a reference measurement and calculating the anthropometric measurements of the person using the determined measurement points, the reference measurement, and the performed perspective correction.

### TECHNICAL FIELD

The present disclosure relates generally to measurement; and more specifically, to a method for determining anthropometric measurements of a person.

### BACKGROUND

Presently, information related to anthropometric measurements of a person finds applicability in various domains such as sports, health, garment industry, demographic research, and so forth. Specifically, anthropometric measurements relate to physical attributes of the person, such as size and shape of body of the person. For example, anthropometric measurements of the person may include circumference of waist of the person, height of the person, and shoulder width of the person.

There exist manual as well as automatic techniques for determining anthropometric measurements of the person. Manual techniques (such as use of tape measures) are prone to human error and therefore may not yield accurate measurements. In contrast, automatic techniques for determining anthropometric measurements may have higher accuracy as compared to the manual techniques. However, the automatic techniques involve use of specialized apparatus, which may be expensive. Further, some automatic techniques may determine anthropometric measurements of the person based on standard body measurements (or pre-determined standard size charts). Therefore, use of such automatic techniques may yield inaccurate results if body measurements of the person are non-standard. Moreover, some automatic techniques may require specific filming conditions (such as bright lighting, clutter-free background and so forth) for optimal use. Therefore, such automatic techniques may yield inaccurate measurements in absence of such filming conditions.

Therefore, in light of the foregoing discussion, there exists a need to overcome the aforementioned drawbacks associated with determining anthropometric measurements of a person.

### SUMMARY

The present disclosure seeks to provide a method for determining anthropometric measurements of a person. The present disclosure seeks to provide a solution to the existing problems of inaccuracy, lack of robustness, and requirement of specialized apparatus in determination of anthropometric measurements of a person. An aim of the present disclosure is to provide a solution that overcomes at least partially the problems encountered in prior art, and provides a simple, easy to implement, and robust method for determining anthropometric measurements of a person.

In one aspect, an embodiment of the present disclosure provides a method for determining anthropometric measurements of a person, the method comprising:
receiving at least two images of the person standing in front of a background, using a camera of a device;
receiving at least two images of the background using the camera;
receiving at least one imaging factor associated with the camera;
computing a statistical background model for the received at least two images of the background;
creating a person probability map using the statistical background model;
determining edges of the person using the person probability map;
determining measurement points using the determined edges of the person and the person probability map;
performing perspective correction for the received at least two images of the person and/or the at least two images of the background using a pitch angle of the device and the at least one imaging factor;
receiving information related to a reference measurement; and
calculating the anthropometric measurements of the person using the determined measurement points, the reference measurement, and the performed perspective correction.

Embodiments of the present disclosure substantially eliminate or at least partially address the aforementioned problems in the prior art, and enables accurate determination of anthropometric measurements of a person.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an environment for determining anthropometric measurements of a person, in accordance with an embodiment of the present disclosure;

FIGS. 2A-2C are illustrations of a user interface for receiving at least two images of the person standing in front of a background using a camera of a device, in accordance with an embodiment of the present disclosure;

FIG. 3 is an illustration of a person probability map, in accordance with an embodiment of the present disclosure;

FIG. 4 is an illustration of an edge representation of determined edges of the person, in accordance with an embodiment of the present disclosure;

FIGS. 5A-5B are illustrations of Y-projection sum curves of a front view and a side view of the person, in accordance with an embodiment of the present disclosure;

FIGS. 6A-6C are schematic illustrations of a determined measurement point, in accordance with an embodiment of the present disclosure;

FIGS. 7A-7C are illustrations of the user interface for displaying the determined anthropometric measurements of the person, in accordance with an embodiment of the present disclosure; and

FIGS. 8A-8B illustrate steps of a method for determining anthropometric measurements of a person, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a. method for determining anthropometric measurements of a person, the method comprising:
receiving at least two images of the person standing in front of a background, using a camera of a device;
receiving at least two images of the background using the camera;
receiving at least one imaging factor associated with the camera;
computing a statistical background model for the received at least two images of the background;
creating a person probability map using the statistical background model;
determining edges of the person using the person probability map;
determining measurement points using the determined edges of the person and the person probability map;
performing perspective correction for the received at least two images of the person and/or the at least two images of the background using a pitch angle of the device and the at least one imaging factor;
receiving information related to a reference measurement; and
calculating the anthropometric measurements of the person using the determined measurement points, the reference measurement, and the performed perspective correction.

The present disclosure provides a method for determining anthropometric measurements of a person. The method described herein significantly reduces possibility of human error to increase accuracy of determined anthropometric measurements. Moreover, the described method does not require use of specialised apparatus. Therefore, costs incurred for implementation of the method are low. Furthermore, the method is adaptable for determining anthropometric measurements for persons with non-standard (or atypical) body measurements. Additionally, the method described in the present disclosure is easy to implement since it is optimised for less than optimal filming conditions, such as poor lighting or low quality camera of the device. Moreover, the described method allows storing the determined anthropometric measurements of the person for a variety of applications.

The method for determining anthropometric measurements of a person comprises receiving at least two images of the person standing in front of a background, using a camera of a device. Specifically, the at least two images of the person are processed to determine the anthropometric measurements of the person. In an embodiment, the device is a small, portable device having a small display or screen, such as a touch screen. Specifically, the screen of the device may be used to display a user interface. In an embodiment, the device also includes a camera to capture images and/or record videos. In an embodiment, the device further comprises an accelerometer. Optionally, the device may be suitable to connect to other user devices and/or a server via a network, such as Internet. Examples of the device include, but are not limited to, a smart phone, a tablet computer, a digital camera, a personal digital assistant (PDA), and so forth.

In an embodiment, receiving at least two images of the person standing in front of a background may comprise displaying a person silhouette on a screen of the device. Specifically, the person silhouette may be a visual representation such as an outline of shape of the person, displayed on the user interface of the device. In such embodiment, the method may further comprise capturing the at least two images of the person, wherein the person conforms to the silhouette. Specifically the person may conform to the silhouette to ensure a correct pose of the person in the at least two captured images of the person. Thereafter, receiving at least two images of the person may comprise indicating capture of each image of the at least two images of the person. Specifically, capture of each image may be indicated by indicating means including, but are not limited to, a countdown clock, camera shutter sound, and camera flash. It may be evident that the background behind the person may be same in each of the received images of the person.

For example, two images of the person may be received, and capture of each image may be indicated by a countdown clock that counts down 5 seconds and plays a sound after capturing each of the two images.

According to an embodiment, the at least two images of the person may comprise at least a front view of the person, and a side view of the person. The front view of the person may facilitate determination of anthropometric measurements such as shoulder width, chest width, inseam, and so forth. The side view of the person may facilitate determination of anthropometric measurements such as upper arm width, armhole width, chest depth and so forth.

The method for determining anthropometric measurements of the person further comprises receiving at least two images of the background using the camera. In an embodiment, receiving the at least two images of the background may comprise capturing the at least two images of the background and indicating capture of the at least two images of the background. Specifically, the at least two images of the background may be captured using the camera of the device. Further, capture of the at least two images of the background may be indicated by the aforementioned indicating means. It may be evident that the person is away from field of view of the camera during capture of the at least two images of the background.

In an embodiment, receiving the at least two images of the background may be interrupted upon detecting presence of the person in field of view of the camera. Specifically, presence of the person may be detected by a face recognition algorithm. According to an embodiment, imaging instructions related to placement of the device and posture of the person, may be displayed on the device. It may be evident that imaging instructions may be displayed on the user interface of the device. In an example, imaging instructions related to placement of the device relate to positioning the device against a wall, placing the device at an appropriate pitch angle (or tilting the device), and so forth. In another example, imaging instructions related to posture of the person relate to arrangement of arms of the person, absence of the person during capture of the at least two images of the background, and so forth. In an example, the pitch angle of the device may lie between 15°-25°.

In an embodiment, the pitch angle of the device may be calculated using the accelerometer of the device. Optionally, the pitch angle of the device may be pre-determined.

Further, the method for determining anthropometric measurements of the person comprises receiving at least one imaging factor associated with the camera. In an embodiment, the at least one imaging factor is at least one of distance between device and the person, field of view of the camera, focal length of the camera, and specifications of image sensor of the camera. According to an embodiment, the at least one imaging factor may be received from the server via the network. Alternatively, the at least one imaging factor may be received from a memory (or storage unit) of the device.

The method for determining anthropometric measurements of the person further comprises computing a statistical background model for the received at least two images of the background. Specifically, the statistical background model may aid in determining characteristics of pixels in the received at least two images of the background. More specifically, the statistical model utilises average and variance of the characteristics of pixels to model effects of noise in the received at least two images of the background.

According to an embodiment, computing the statistical background model may comprise calculating lightness (a), relative red colour (r), and relative green colour (g) for all pixels in each of the received at least two images of the background. Specifically, lightness (a), relative red colour (r), and relative green colour (g) may be calculated for each pixel within image width (W) and image height (H) using mathematical formulae. In such mathematical formulae, each pixel within image width (W) and image height (H) may be represented as i(w,h) wherein wε{0, 1, . . . , W−1} and hε{0, 1, . . . , H−1}. Additionally, each pixel in the images of the background may be represented in terms of RGB (Red, Green, Blue) colour components as i(w,h)={iᵣ(w,h), i_{g}(w,h), i_{b}(w,h)}. In an example, the mathematical formulae for calculating lightness (a), relative red colour (r), and relative green colour (g) may be:

$$a ( w , h ) = {i}_{r} ( w , h ) + {i}_{g} ( w , h ) + {i}_{b} ( w , h )$$

$$g ( w , h ) = \frac{{i}_{g} ( w , h )}{a ( w , h )}$$

$$r ( w , h ) = \frac{{i}_{r} ( w , h )}{a ( w , h )}$$

In such embodiment, the method may further comprise calculating average lightness (ā), average relative red colour (r̅), and average relative green colour (g̅) for all pixels. Specifically, the average lightness (ā), average relative red colour (r̅), and average relative green colour (g̅) may be calculated by taking into consideration all ‘n’ received images of the background. For example, the average lightness (ā), average relative red colour (r̅), and average relative green colour (g̅) may be calculated as:

$$\overline{a} ( w , h ) = \frac{{\sum }_{i = 1}^{n} {a}_{i} ( w , h )}{n}$$

$$\overline{r} ( w , h ) = \frac{{\sum }_{i = 1}^{n} {r}_{i} ( w , h )}{n}$$

$$\overline{g} ( w , h ) = \frac{{\sum }_{i = 1}^{n} {g}_{i} ( w , h )}{n}$$

Thereafter, computing the statistical background model may comprise calculating variance of lightness (σₐ), variance of relative red colour (σᵣ), and variance of relative green colour (σ_{g}) for all pixels. In an example, the aforementioned variances may be calculated as:

$${σ}_{a} ( w , h ) = \frac{{\sum }_{i = 1}^{n} {( {a}_{i} ( w , h ) - \overline{a} ( w , h ) )}^{2}}{n}$$

$${σ}_{r} ( w , h ) = \frac{{\sum }_{i = 1}^{n} {( {r}_{i} ( w , h ) - \overline{r} ( w , h ) )}^{2}}{n}$$

$${σ}_{g} ( w , h ) = \frac{{\sum }_{i = 1}^{n} {( {g}_{i} ( w , h ) - \overline{g} ( w , h ) )}^{2}}{n}$$

The computation of the statistical background model may further comprise calculating averages of calculated variances of lightness (σ̅ₐ) relative red colour (σ̅ᵣ), and relative green colour (σ̅_{g}). For example, the averages of calculated variances may be calculated using undermentioned formulae:

$${\overline{σ}}_{a} = \frac{{\sum }_{h = 0}^{H - 1} {\sum }_{w = 0}^{W - 1} {σ}_{a} ( w , h )}{H * W}$$

$${\overline{σ}}_{r} = \frac{{\sum }_{h = 0}^{H - 1} {\sum }_{w = 0}^{W - 1} {σ}_{r} ( w , h )}{H * W}$$

$${\overline{σ}}_{g} = \frac{{\sum }_{h = 0}^{H - 1} {\sum }_{w = 0}^{W - 1} {σ}_{g} ( w , h )}{H * W}$$

Optionally, very small values of the calculated averages of variances of lightness (σ̅ₐ), relative red colour (σ̅ᵣ), and relative green colour (σ̅_{g}) may be truncated to experimentally determined limits as follows:

σ̅ₐ>a_{LOW}, σ̅ₐ<a_{HIGH}, wherein a_{LOW} refers to a lower limit of lightness and a_{HIGH} refers to an upper limit of lightness.
σ̅ᵣ>r_{LOW}, σ̅ᵣ<r_{HIGH}, wherein r_{LOW} refers to a lower limit of relative red colour and r_{HIGH} refers to an upper limit of relative red colour.
σ̅_{g}>g_{LOW}, σ̅_{g}<g_{HIGH} wherein g_{LOW} refers to a lower limit of relative green colour and g_{HIGH} refers to an upper limit of relative green colour.

In an example, experimentally determined values for a_{Low}, r_{LOW} and g_{LOW} may be 2.0, 2.0*10⁻⁶, and 2.0*10⁻⁶ respectively. Further, experimentally determined values for a_{HIGH}, r_{HIGH} and g_{HIGH} may be 10.0, 2.0*10⁻⁵, and 2.0*10⁻⁵ respectively.

Further, the computation of the statistical background model may comprise truncating the variances of lightness (σₐ), relative red colour (σᵣ), and relative green colour (σ_{g}) for all pixels in proportion to the averages of calculated variances. Specifically, truncation may be performed to limit extreme variations in values of variances and to prevent values of variances from being too close to zero. For example, the variances of lightness (σₐ), relative red colour (σᵣ), and relative green colour (σ_{g}) may be truncated as:

σₐ(w,h)ε{a*σ̅ₐ,b*σ̅ₐ}, where a<b

σᵣ(w,h)ε{a*σ̅ᵣ,b*σ̅ᵣ}, where a<b

σ_{g}(w,h)ε{a*σ̅_{g},b*σ̅_{g}}, where a<b

In the aforementioned formulae, ‘a’ and ‘b’ may be constants. In an example, experimentally determined values of ‘a’ and ‘b’ may be 0.25 and 1.25 respectively.

The method for determining anthropometric measurements of the person further comprises creating a person probability map using the statistical background model. Specifically, the person probability map may utilise dissimilarities in characteristics of pixels of the received at least two images of the background and the pixels of the received at least two images of the person, to define (or determine) a region of high probability for presence of the person within the received images. More specifically, creation of the person probability map may rely on separating (or differentiating between) pixels representing the background and shadows from pixels representing the person.

In an embodiment, the method for creating the person probability map using the statistical background model may comprise calculating lightness (aₚₑᵣₛₒₙ), relative red colour (rₚₑᵣₛₒₙ), and relative green colour (gₚₑᵣₛₒₙ) for all pixels in each of the received at least two images of the person. It may be evident that lightness (aₚₑᵣₛₒₙ), relative red colour (rₚₑᵣₛₒₙ), and relative green colour (gₚₑᵣₛₒₙ) may be calculated in a similar manner as calculated lightness (a), relative red colour (r), and relative green colour (g) described previously. It may also be evident that each pixel in the images of the person may be represented in terms of RGB colour components as iₚₑᵣₛₒₙ(w,h)={iᵣₚₑᵣₛₒₙ(w,h), i_{gperson}(w,h), i_{bperson}(w,h)}. In an example, the lightness (aₚₑᵣₛₒₙ), relative red colour (rₚₑᵣₛₒₙ), and relative green colour (gₚₑᵣₛₒₙ) may be calculated as:

$${a}_{person} ( w , h ) = {i}_{r person} ( w , h ) + {i}_{gperson} ( w , h ) + {i}_{bperson} ( w , h )$$

$${r}_{person} ( w , h ) = \frac{{i}_{rperson} ( w , h )}{{a}_{person} ( w , h )}$$

$${g}_{person} ( w , h ) = \frac{{i}_{gperson} ( w , h )}{{a}_{person} ( w , h )}$$

Thereafter, creating the person probability map may comprise calculating lightness change (Δa) and colour change (ΔColour) by comparing the calculated lightness (aₚₑᵣₛₒₙ), relative red colour (rₚₑᵣₛₒₙ), and relative green colour (gₚₑᵣₛₒₙ) with the statistical background model. Specifically, the comparison relates to determining distortion of pixels in the images of the person from expected averages (such as average lightness (ā), average relative red colour (r̅), and average relative green colour (g̅)) of the statistical background model, with respect to calculated variances (such as variance of lightness (σₐ), variance of relative red colour (σᵣ), and variance of relative green colour (σ_{g})). In an example, lightness change (Δa) and colour change (ΔColour) may be calculated as:

$$Δ a ( w , h ) = \frac{( {a}_{person} ( w , h ) - \overline{a} ( w , h ) )}{{σ}_{a} ( w , h )}$$

$$Δ Color ( w , h ) = \vert \frac{( {r}_{person} ( w , h ) - \overline{r} ( w , h ) )}{{σ}_{r} ( w , h )} \vert + \vert \frac{( {g}_{person} ( w , h ) - \overline{g} ( w , h ) )}{{σ}_{g} ( w , h )} \vert$$

Further, creating the person probability map may comprise defining at least one discriminant function based on the calculated colour change. For example, two discriminant functions may be defined and represented hereinafter as DFₜₒₚ and DF_{bottom}. The two exemplary discriminant functions may be used to separate the person and the background on positive and negative sides of a lightness change (Δa) axis. In an example, the two exemplary discriminant functions may be:

DFₜₒₚ(ΔColor)=T₁ΔColor+T₂ΔColor+T₃ΔColor+T₄ and,

DF_{bottom}(ΔColor)=B₁ΔColor+B₂ΔColor+B₃ΔColor+B₄

In the aforementioned equations T1, T2, T3, T4, B1, B2, B3, and B4 may be experimentally determined constants to produce a good class separation on both sides of the lightness change (Δa) axis.

Thereafter, the method for creating the person probability map may comprise calculating probability of each pixel in each of the received at least two images of the person to belong to the person (Pₚₑᵣₛₒₙ), depending on the discriminant functions, lightness change (Δa) and colour change (ΔColour). Specifically, the probability of a pixel to belong to the person (Pₚₑᵣₛₒₙ) may be calculated using lightness change (Δa) distance between discriminant functions on a same side of the lightness change (Δa) axis. In an example, the probability of a pixel to belong to the person (Pₚₑᵣₛₒₙ) may be calculated as:

$${P}_{person} = \{ \begin{matrix}Δ a ( w , h ) - {DF}_{top} ( Δ Color ( w , h ) ) , & if Δ Color ( w , h ) \geq 0 \\ {DF}_{bottom} ( Δ Color ( w , h ) ) - Δ a ( w , h ) , & if Δ Color ( w , h ) < 0\end{matrix}$$

Optionally, probability values (Pₚₑᵣₛₒₙ) may be truncated to increase computation efficiency. For example, the probability values (Pₚₑᵣₛₒₙ) may be truncated to lie between 0 and 255.

Further, creating the person probability map using the statistical background model may comprise displaying the calculated probabilities in a RGB colour channel. Specifically, pixels with high probability of belonging to the person (Pₚₑᵣₛₒₙ) may be visually represented differently (for example, in a specific colour) in order to distinguish therebetween (with respect to pixels with low probability of belonging to the person). It may be evident that the pixels with higher probability of belonging to the person (Pₚₑᵣₛₒₙ) may define a region of high probability of the person. For example, the calculated probabilities (Pₚₑᵣₛₒₙ) may be displayed in a green RGB colour channel.

The method for determining anthropometric measurements of the person further comprises determining edges of the person using the person probability map. Specifically, edges of the person may be determined to ascertain contour of body of the person and to discard edges present in the background.

In an embodiment, determining edges of the person using the person probability map may comprise determining X and Y directional gradients (Gx and Gy) of the received at least two images of the person, the received at least two images of the background, and the person probability map using Sobel operators. For example, X and Y directional gradients (Gx and Gy) may be mathematically determined using 3×3 kernel Sobel operators as follows:

$${G}_{x} = [ \begin{matrix}- 1 & 0 & 1 \\ - 2 & 0 & 2 \\ - 1 & 0 & 1\end{matrix} ]$$

$${G}_{y} = [ \begin{matrix}- 1 & - 2 & - 1 \\ 0 & 0 & 0 \\ 1 & 2 & 1\end{matrix} ]$$

It may be evident to aₚₑᵣₛₒₙ skilled in the art that X and Y directional gradients (Gx and Gy) may alternatively be determined using other suitable mathematical operators such as Prewitt operator or Kirsch operator.

Optionally, determining edges of the person may further comprise determining discrete edge direction (θ) and edge magnitude (∇G) from the X and Y directional gradients (Gx and Gy). Specifically person gradients may be thinned by retaining only high gradients in the discrete edge directions in a 4-pixel distance perpendicular to edges. In an example, discrete edge magnitude values may be represented as sectors within a circle to represent the discrete edge magnitudes corresponding to angles within the sectors. Alternatively, continuous edge direction and edge magnitude may be calculated.

Further, determining edges of the person may comprise calculating preliminary edges of the person using the X and Y directional gradients of the received at least two images of the person. For example, the preliminary edges of the person (∇Gₚₑᵣₛₒₙ) may be determined using the undermentioned equation for calculating edge magnitude (∇G), in relation with the received at least two images of the person.

∇G(w,h)=\sqrt{Gₓ²(w,h)+G_{y}²(w,h)}

Thereafter, determining edges of the person may comprise calculating background edges in at least one image of the received at least two images of the background. For example, background edges (∇G_{background}) may be determined using the aforementioned equation for calculating edge magnitude (∇G).

The method for determining edges of the person may further comprise computing the edges of the person (Gₚₑᵣₛₒₙ) from the calculated preliminary edges of the person. Optionally, computing the edges of the person (Gₚₑᵣₛₒₙ) may also take into account the calculated background edges (∇G_{background}). In an embodiment, computing the edges of the person (Gₚₑᵣₛₒₙ) from the calculated preliminary edges of the person may comprise retaining the calculated preliminary edges of the person if same directional edges are present in the person probability map and reducing the calculated preliminary edges of the person if the same directional edge is present within the region of high probability of the person (as described above). In an example, the edges of the person (Gₚₑᵣₛₒₙ) may be computed as follows:

$${G}_{person} ( w , h ) = \{ \begin{matrix}∇ {G}_{person} ( w , h ) , & \begin{matrix}if ( ∇ {G}_{Pperson} ( w , h ) > c ) and \\ ( {θ}_{Pperson} ( w , h ) = {θ}_{person} ( w , h ) )\end{matrix} \\ ∇ {G}_{person} ( w , h ) * d , & \begin{matrix}if ( ∇ {G}_{Pperson} ( w , h ) > c ) and \\ ( {P}_{person} ( w , h ) > e )\end{matrix} \\ ∇ {G}_{person} ( w , h ) - ∇ {G}_{backgrtound} & else\end{matrix}$$

In the aforementioned equation, ‘c’, ‘d’, and ‘e’ may be experimentally determined or may be pre-defined constants.

Optionally, at least one of the computed edges of the person (Gₚₑᵣₛₒₙ) may be discarded if the computed edges of the person (Gₚₑᵣₛₒₙ) lie below a pre-determined threshold. More optionally, an edge representation of the determined edges of the person may be displayed on the user interface of the device.

Optionally, determining edges of the person further comprises computing X and Y directional components (Gxₚₑᵣₛₒₙ and Gyₚₑᵣₛₒₙ) of the edges of the person. For example, the X and Y directional components (Gxₚₑᵣₛₒₙ and Gyₚₑᵣₛₒₙ) may be calculated as follows:

$${Gx}_{person} ( w , h ) = \{ \begin{matrix}{G}_{person} ( w , h ) , & if θ ( w , h ) = 0 \\ \frac{{G}_{person} ( w , h )}{\sqrt{2}} , & if θ ( w , h ) = 1 or if θ ( w , h ) = 3 \\ 0 , & otherwise\end{matrix} \\ {Gy}_{person} ( w , h ) = \{ \begin{matrix}{G}_{person} ( w , h ) , & if θ ( w , h ) = 2 \\ \frac{{G}_{person} ( w , h )}{\sqrt{2}} , & if θ ( w , h ) = 1 or if θ ( w , h ) = 3 \\ 0 , & otherwise\end{matrix}$$

In the aforementioned equations, θ(w,h) represents discrete edge direction.

Thereafter, the method for determining anthropometric measurements of the person comprises determining measurement points using the determined edges of the person and the person probability map. In an embodiment, determining measurement points using the determined edges of the person may comprise calculating Y-projection sum (PprojY) of the calculated probability of each pixel in each of the received at least two images of the person to belong to a person. Specifically, the Y-projection sum (PprojY) may be a count of probability values (Pperson values) greater or equal to a threshold. The threshold may or may not be pre-determined. For example, the Y-projection sum (PprojY) may be calculated as follows:

$${P}_{{proj}_{Y}} ( w ) = {\sum }_{h = 0}^{H - 1} \{ \begin{matrix}1 , & {P}_{person} ( w , h ) \geq {TH}_{{P}_{person}} \\ 0 , & else\end{matrix}$$

In the aforementioned equation, TH_{Pperson} may be the threshold. In an example, TH_{Pperson} may be pre-determined and equal to ‘50’.

In an embodiment, a front view of the person may produce a fork-like shape in a Y-projection sum curve. According to an embodiment, the Y-projection sum curve may be a curve depicting the Y-projection sum of the at least two images of the person on the vertical axis and image width coordinate ‘w’ on the horizontal axis. In an embodiment, a side view of the person may produce a peak-like shape in a Y-projection sum curve.

Thereafter, determining measurement points may comprise estimating center of body of the person and width of the body of the person using a first mask function and the calculated Y-projection sum (PprojY). Specifically, the center of body of the person may be estimated by moving the first mask function (represented hereinafter as f_{fork1}) along the Y-projection sum curve (of the front view of the person) to detect a combination of center location and fork width that yields highest product. More specifically, the first mask function (f_{fork1}) may be moved along the Y-projection sum curve (of the front view of the person) with varying fork widths. In such embodiment, quarter body distance ‘d’ (or quarter fork), and search area may be limited as position and/or posture of the person may be controlled (since the person conforms to the silhouette during capture of the at least two images of the person). The estimated center of body of the person and width of the body of the person may further reduce (or limit) search areas for each measuring point. In an example, the first mask function (f_{fork1}) and quarter body distance ‘d’, and image width coordinate ‘w’ may be may be calculated as follows:

$${f}_{fork 1} ( w , d ) = - {P}_{projY} ( w - 3 d ) + {P}_{projY} ( w - 2 d ) + {P}_{projY} ( w - 1.8 d ) - \sqrt{{( {P}_{proyY} ( w - d ) - {P}_{projY} ( w + d ) )}^{2}} - \sqrt{{( {P}_{proyY} ( w - 2 d ) - {P}_{projY} ( w + 2 d ) )}^{2}} + {P}_{projY} ( w + 1.8 d ) + {P}_{projY} ( w + 2 d ) - {P}_{projY} ( w + 3 d )$$

$$d \geq \frac{W}{24} , d \leq \frac{W}{12} , d ∈ {Z}^{+} , w \geq \frac{3 W}{8} , w \leq \frac{5 W}{8} , w ∈ {Z}^{+}$$

Similarly, determining measurement points may further comprise estimating body depth of the person using a second mask function and the calculated Y-projection sum (PprojY). Specifically, the body depth of the person may be estimated by moving the second mask function (represented hereinafter as f_{fork2}) along the Y-projection sum curve (of the side view of the person) to detect a combination of center location and fork width that yields highest product. More specifically, the second mask function (f_{fork2}) may be moved along the Y-projection sum curve (of the side view of the person) with varying fork widths. In such embodiment, quarter depth distance ‘f’ (or quarter peak width), and search area may be limited as position and/or posture of the person may be controlled (since the person conforms to the silhouette during capture of the at least two images of the person). Additionally, the centre of body of the person may also be found using the second mask function and the calculated Y-projection sum (PprojY). In an example, the second mask function (f_{fork2}) and quarter depth distance ‘f’, and image width coordinate ‘w’ may be calculated as follows:

$${f}_{fork 2} ( w , f ) = {P}_{projY} ( w - 2 f ) + {P}_{projY} ( w - f ) + {P}_{projY} ( w ) + {P}_{projY} ( w + f ) + {P}_{projY} ( w + 2 f )$$

$$f \geq \frac{W}{100} , f \leq \frac{W}{25} , f ∈ {Z}^{+} , w \geq \frac{W}{4} , w \leq \frac{3 W}{4} , w ∈ {Z}^{+}$$

Thereafter, determining measurement points may comprise calculating summed area tables using the person probability map and X and Y directional components of the edges of the person (Gxₚₑᵣₛₒₙ and Gyₚₑᵣₛₒₙ). Specifically, the summed area tables (also known as integral images) may be used to efficiently generate a sum of values inside a rectangular area. More specifically, the summed area tables may be used to locate feature shapes on the person probability map. The feature shapes may be located by adding and subtracting sums of rectangular areas (generated using summed area tables) based on the feature shape. In an example, rectangular areas to be added may be represented in green colour, and rectangular areas to be subtracted may be represented in red colour. Specifically, the rectangular areas to be added and subtracted may be represented distinctly to distinguish therebetween.

Further, determining measurement points may comprise locating extremities of the body of the person. Specifically, the extremities (or extreme ends of the body of the person, such as top of head, tip of feet, and so forth) may be located using the summed area tables, person probability map, and the determined edges of the person. Moreover, determination of the extremities reduces search area to detect the measurement points.

Thereafter, determining measurement points may comprise detecting measurement points using the located extremities, rectangle based features, and the determined edges of the person. For example, a measurement point may be detected by locating a feature shape thereof on the person probability map (as described above), determining X and Y directional edges of the person (Gxₚₑᵣₛₒₙ and Gyₚₑᵣₛₒₙ), and assigning weight of the measurement point. Specifically, the measurement point with highest value of resultant sum of weighted probability and directional edge sums, and weighted edges of the person may be selected as the measurement point. According to an embodiment, the weighted probability and directional edge sums may include but not be limited to weighted sum of feature shape on the person probability map, weighted sum of X directional component of edge of the person, and weighted sum of Y directional component of edge of the person. In an example, the resultant sum for selection of the measurement point may be calculated as:

$${F}_{point} ( w , h ) = {p}_{1} {S}_{Pperson} + {p}_{2} {S}_{Gxperson} + {p}_{3} {S}_{Gyperson} + {p}_{4} {S}_{Gperson} ( w , h )$$

In the aforementioned equation, ‘Fₚₒᵢₙₜ(w,h)’ denotes resultant sum of a measurement point, ‘p₁S_{Pperson}’ denotes weighted sum of feature shape on the person probability map (or weighted sum of added and subtracted areas of person probability), ‘p₂S_{Gxperson}’ denotes weighted sum of X directional component of edge of the person, ‘p₃S_{Gyperson}’ denotes weighted sum of Y directional component of edge of the person, and ‘p₄S_{Gperson}(w,h)’ denotes weighted edges of the person. It may be evident that p1 p2, p3 and p4 are the assigned weights of the measurement point. Further, the assigned weights are specific to measurement points, and may be experimentally determined. In an embodiment, the assigned weight of the measurement point may be higher if the measurement point is detected on the determined edges of the person. It may also be evident that the highest value of the resultant sum ‘Fₚₒᵢₙₜ(w,h)’ may be denoted as MAX(Fₚₒᵢₙₜ(w,h)) and coordinates of a measurement point corresponding to MAX(Fₚₒᵢₙₜ(w,h)) may be selected as the measurement point.

The method for determining anthropometric measurements of the person further comprises performing perspective correction for the received at least two images of the person and/or the at least two images of the background using a pitch angle of the device and the at least one imaging factor. Specifically, perspective correction transforms coordinates of the determined measurement points (on the received images of the person and/or the received images of the background) to a perspective corrected coordinate plane (or perspective corrected coordinates) to accommodate for placement of the device at the pitch angle (or device tilt). More specifically, perspective correction may use the at least one imaging factor such as distance between device and the person, field of view of the camera, and so forth. In an example, perspective correction may be performed using the following equations wherein ‘ε’ denotes the pitch angle of the device, ‘φ’ denotes angle between point P1 and an optical axis of lens of the camera, and ‘β’ denotes angle between point P2 and the optical axis.

$$P {1}^{′} = \{ {w}^{′} , {h}^{′} \} = \{ w [ 1 + \frac{sin ɛ sin ϕ}{sin ( {90}^{°} - ɛ - ϕ )} ] , h [ \frac{sin ( {90}^{°} + ϕ )}{sin ( {90}^{°} - ɛ - ϕ )} ] \}$$

In the aforementioned equation, P1′ denotes perspective corrected coordinates of a measurement point P1 above the optical axis.

$$P {2}^{′} = \{ {w}^{′} , {h}^{′} \} = \{ w [ \frac{sin ( {90}^{°} - ɛ ) sin ( {90}^{°} - β )}{sin ( {90}^{°} + β - ɛ )} ] , h [ \frac{sin ( {90}^{°} - β )}{sin ( {90}^{°} + β - ɛ )} ] \}$$

In the aforementioned equation, P2′ denotes perspective corrected coordinates of a measurement point P2 below the optical axis.

Optionally, lens distortion may be corrected before performing perspective correction, provided the lens distortion of the camera is known.

Thereafter, the method for determining anthropometric measurements of the person comprises receiving information related to a reference measurement. Specifically, the reference measurement may be utilised as a reference (or source of information) for calculation of the anthropometric measurements of the person. According to an embodiment, the reference measurement may be an anthropometric measurement of the person, such as height of the person. In another embodiment, the reference measurement may be a measurement of an object present in the received at least two images of the person and/or the at least two images of the background. Examples of such objects may include, but are not limited to, a closet, a nightstand, and a bed.

In an embodiment, the information related to the reference measurement may be received as an input from the user. For example, the user may input his/her height on the user interface of the device. In an example, an instruction may be displayed on the user interface to receive the reference measurement as input from the person. In another embodiment, the information related to the reference measurement may be received from the server via the network.

Further, the method for determining anthropometric measurements of the person comprises calculating the anthropometric measurements of the person using the determined measurement points, the reference measurement, and the performed perspective correction. Specifically, the anthropometric measurements of the person may be calculated by utilising perspective corrected coordinates of measurement points and scaling (or representing proportionally) the reference measurement to determine measurement (for example, length) between the measurement points. In an embodiment, measurements such as circumference of body parts of the person may be calculated using a mathematical formula for calculating perimeter of ellipse.

In an embodiment, the determined anthropometric measurements of the person may be displayed on the user interface of the device. Optionally, the received at least two images of the person may be displayed on the user interface with the perspective corrected coordinates of measurement points, and/or measurement (for example, length) between the measurement points.

Optionally, the method for determining anthropometric measurements of the person may further comprise storing the determined anthropometric measurements of the person. Specifically, the determined anthropometric measurements of the person may be stored for a variety of applications such as procuring medical data of the person, designing athletic training modules for the person, selecting clothing size for the person, and so forth. In an embodiment, the determined anthropometric measurements of the person may be stored on the memory (or storage unit) of the device. In another embodiment, the determined anthropometric measurements of the person may be stored on the server.

According to an embodiment, the method for determining anthropometric measurements of the person may further comprise making a clothing size suggestion based on the determined anthropometric measurements of the person. Specifically, the clothing size suggestion may be utilised by the person for purchasing garments of suitable size. More specifically, the clothing size suggestion may be made by comparing the determined anthropometric measurements of the person with clothing size charts. In an example, the clothing size suggestion may be a suggestion to buy clothes of US size 10 for a woman with determined anthropometric measurements as “Chest Circumference=36 inch, Waist=28.5 inch, and Hip Circumference=39 inch”.

In an embodiment, the method for determining anthropometric measurements of the person may comprise providing setup instructions to the person, on the device. Specifically, the setup instructions may be provided to the person for efficiently capturing the at least two images of the person and the at least two images of the background. According to an embodiment the setup instructions may be provided to the person on the user interface of the device. For example, the setup instructions may be provided in form of images on the device. In another example, the setup instructions may be in form of an instructional video. According to another embodiment, the setup instructions may be provided to the person via audio instructions.

In an embodiment, the setup instructions may comprise information related to at least one of clothing requirements for the person, posture of the person, specifications for the background, and placement of the device. For example, the setup instructions may be “Please dress in close fitting clothing”, “Place your device on the floor, leaning against a wall”, “Position yourself inside the person silhouette”, “Please stand at an approximate distance of 2 metres from the device”, and “Please ensure ambient lighting and good colour contrast between you and the background for optimum results”.

Optionally the method for determining anthropometric measurements of the person may comprise normalizing the received at least two images of the person standing in front of the background relative to one image of the received at least two images of the background. Specifically, the received images of the person may be normalized relative to one image of the received background image to ensure minimal colour and lightness variation between all the received images. More specifically, RGB (Red, Green, Blue) colour components of the received at least two images of the person may be normalized.

In an embodiment, normalizing the received at least two images of the person standing in front of the background relative to one image of the received at least two images of the background may comprise obtaining a plurality of samples corresponding to a plurality of areas in the received images of the person. For example, eight samples may be obtained corresponding to each of two received images of the person. Thereafter, normalizing the received at least two images of the person may comprise calculating mean values corresponding to each of red, blue and green colour channels for each of the plurality of samples. Further, normalizing the received at least two images of the person may comprise comparing the calculated mean values for each of the plurality of samples to corresponding areas in the one image of the received at least two images of the background. Specifically, the comparison may be performed to determine difference between samples for corresponding areas in the received images of the person and the one image of the received at least two images of the background. Thereafter, normalizing the received at least two images of the person may comprise calculating average of differences between samples for corresponding areas in the received images of the person and the one image of the received at least two images of the background. Further, normalizing the received at least two images of the person may comprise subtracting the calculated average of differences from corresponding areas in the received images of the person for normalization.

Optionally, the present disclosure provides a computer program product comprising a non-transitory computer-readable storage medium having computer-readable instructions stored thereon, the computer-readable instructions being executable by a computerized device comprising processing hardware to execute the method for determining anthropometric measurements of the person described hereinabove.

### DETAILED DESCRIPTION OF THE DRAWINGS

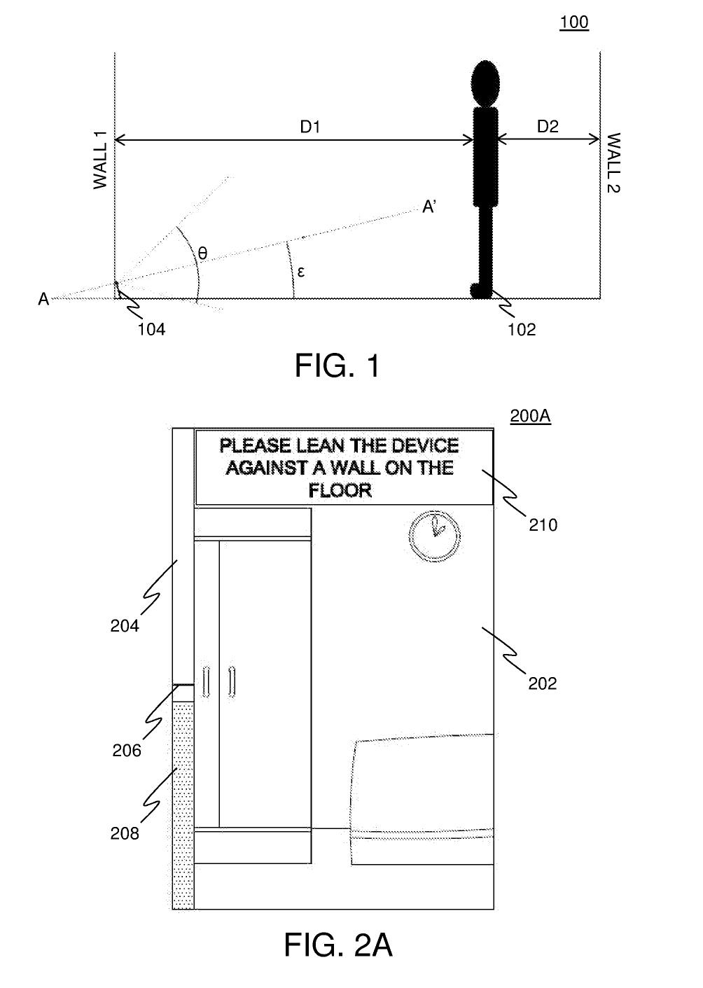

Referring to FIG. 1, illustrated is a schematic illustration of an environment 100 for determining anthropometric measurements of a person, in accordance with an embodiment of the present disclosure. The environment 100 includes a person 102 and a device 104. As shown, the device 104 leans against ‘WALL 1’ on a floor of the environment 100 at a distance D1 from the person 102. For example, distance D1 may be approximately 2 metres. Further, the person 102 is at a distance D2 from a background i.e, ‘WALL 2’. For example, distance D2 may be greater than 0.5 metres. As shown, optical axis of lens of the camera is indicated as A-A′, field of view of the camera is indicated by angle ‘0’, and pitch angle of the device is indicated by ‘E’. In an example, E may lie between 15°-25°.

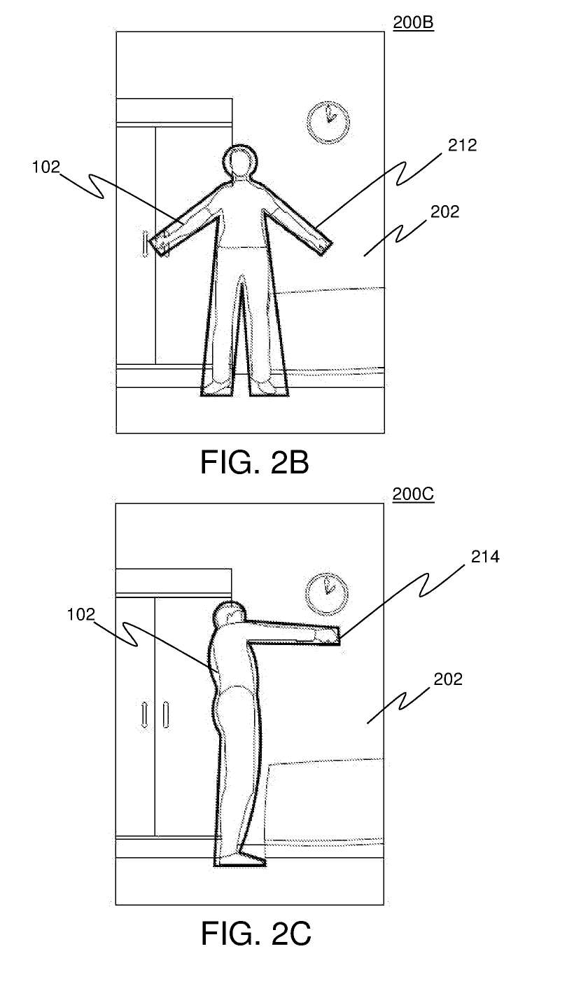

Referring to FIG. 2A, illustrated is a user interface 200A for receiving at least two images of the person (such as the person 102 of FIG. 1) standing in front of a background 202 using a camera of a device (such as the device 104 of FIG. 1), in accordance with an embodiment of the present disclosure. As shown, the background 202 is a scene in field of view of camera of the device 104. It may be evident that the background 202 excludes the person 102. As shown, the user interface 200A displayed on a screen of the device 104 includes an angle bar 204 for placing the device 104 at an appropriate pitch angle, for example 20°. The appropriate pitch angle (which may be pre-determined) is denoted as line 206 on the angle bar 204. As shown, a shaded region 208 on the angle bar 204 indicates the pitch angle as calculated using an accelerometer of the device 104. It may be evident that the device 104 is considered to be correctly placed when the shaded region 208 extends till the line 206 on the angle bar 204. A setup instruction 210 related to placement of the device 104 is displayed on the user interface 200A. For example, the setup instruction 210 is “Please lean the device against a wall on the floor”.

Referring to FIG. 2B, illustrated is a user interface 20013 for receiving a front view image of the person 102 standing in front of the background 202 using the camera of the device 104, in accordance with an embodiment of the present disclosure. A person silhouette 212 is displayed on the screen of the device 104. As shown, the person 102 conforms to the silhouette 212, and the front view image of the person 102 is captured. The capture of the front view image may be indicated using indicating means such as camera shutter sound.

Referring to FIG. 2C, illustrated is a user interface 200C for receiving a side view image of the person 102 standing in front of the background 202 using the camera of the device 104, in accordance with an embodiment of the present disclosure. A person silhouette 214 is displayed on the screen of the device 104. As shown, the person 102 conforms to the silhouette 214, and the side view image of the person 102 is captured. It may be evident that the person silhouette 214 for capturing the side view image of the person is different from the person silhouette 212 for capturing the front view image of the person. The capture of the side view image may be indicated using indicating means such as camera shutter sound.

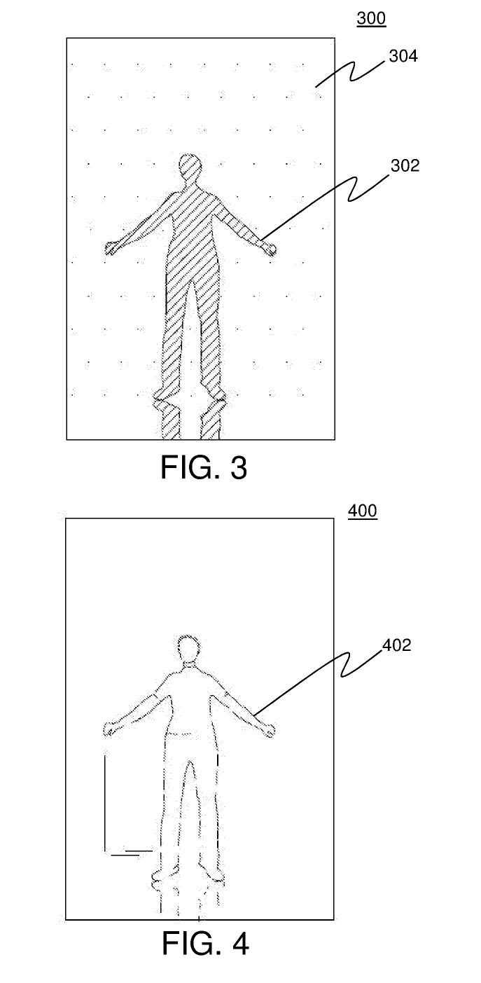

Referring to FIG. 3, illustrated is a person probability map 300, in accordance with an embodiment of the present disclosure. Specifically, the person probability map 300 represents a probability of each pixel in a front view image of a person (such as the front view image of the person 102 received using the user interface 20013) to belong to the person 102. As shown, pixels with high probability of belonging to the person 102, define a region 302 of high probability of the person 102. Similarly, pixels with low probability of belonging to the person 102, define a region 304 of low probability of the person 102. It may be evident that the regions 302 and 304 are represented differently in order to distinguish therebetween. For example, the region 302 may be represented in a green RGB colour channel.

Referring to FIG. 4, illustrated is an edge representation 400 of determined edges 402 of the person 102, in accordance with an embodiment of the present disclosure. Specifically, the edge representation 400 represents the edges 402 of the person 102, determined using the person probability map 300.

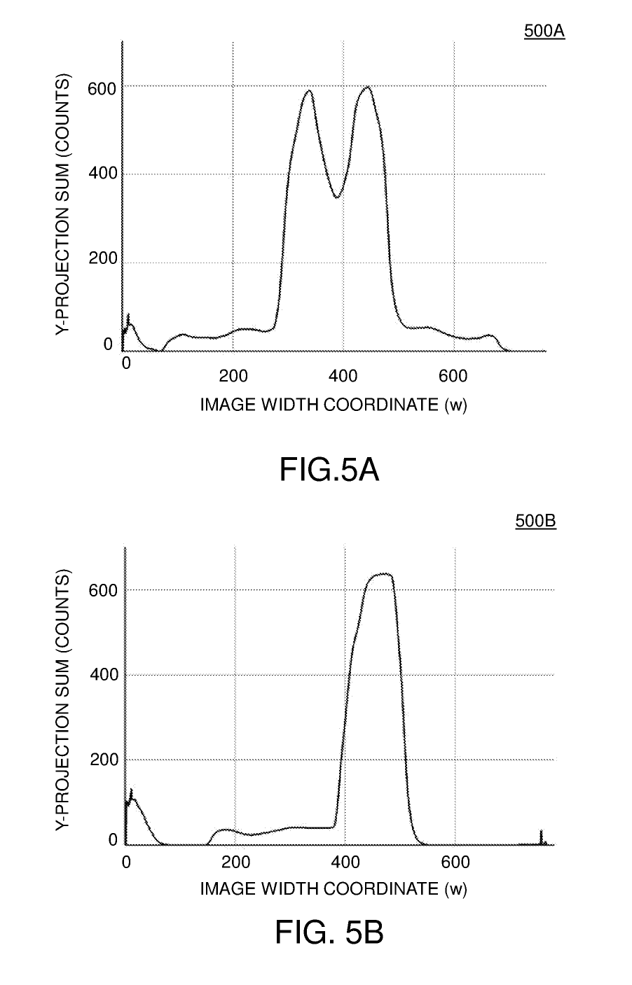

Referring to FIG. 5A, illustrated is a Y-projection sum curve 500A of a front view the person, in accordance with an embodiment of the present disclosure. As shown, a vertical axis of the Y-projection sum curve 500A depicts the Y-projection sum of the front view image of the person, and a horizontal axis of the Y-projection sum curve 500A depicts image width coordinate ‘w’. In an example, center of body of the person and width of the body of the person may be estimated using a first mask function and the Y-projection sum curve 500A.

Referring to FIG. 5B, illustrated is a Y-projection sum curve 50013 of a side view the person, in accordance with an embodiment of the present disclosure. As shown, a vertical axis of the Y-projection sum curve 50013 depicts the Y-projection sum of the side view image of the person, and a horizontal axis of the Y-projection sum curve 50013 depicts image width coordinate ‘w’. In an example, body depth of the person may be estimated using a second mask function and the Y-projection sum curve 50013.

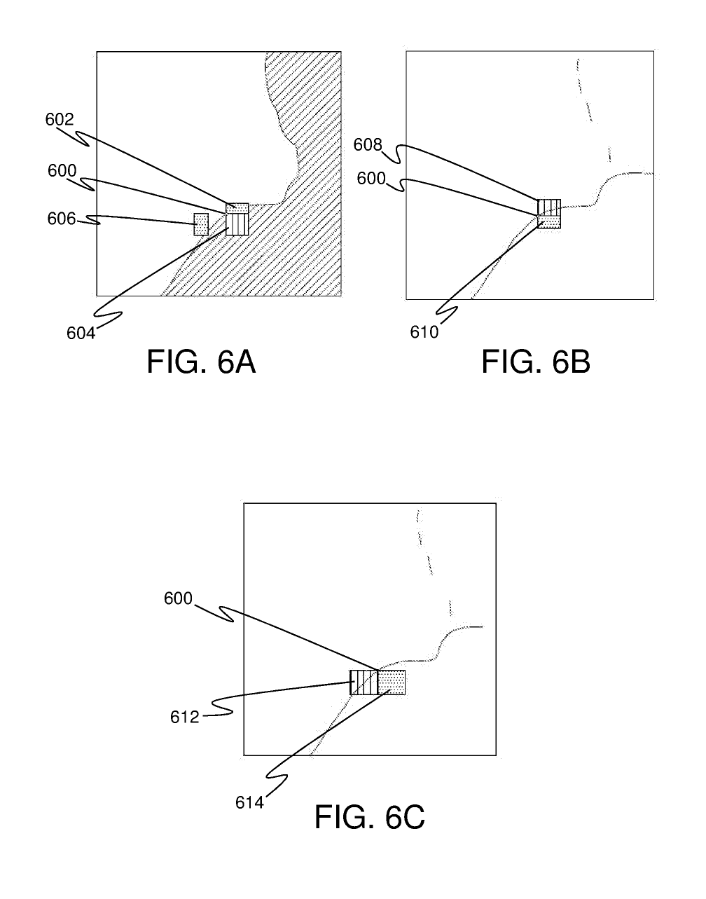

Referring to FIG. 6A, illustrated is a schematic illustration of a determined measurement point 600, in accordance with an embodiment of the present disclosure. Specifically, the measurement point 600 is determined using summed area tables to generate sums of values inside rectangular areas 602, 604 and 606 on the person probability map 300. For example, the rectangular areas 602 and 606 to be subtracted and the rectangular area 604 to be added are represented distinctly to distinguish therebetween.

Referring to FIG. 6B, illustrated is a schematic illustration of the determined measurement point 600, in accordance with an embodiment of the present disclosure. Specifically, the measurement point 600 is determined using Y-directional edges of a person (such as the person 102) and summed area tables to generate sums of values inside rectangular areas 608 and 610 on the edge representation 400. For example, the rectangular areas 608 to be added and the rectangular area 610 to be subtracted are represented distinctly to distinguish therebetween.

Referring to FIG. 6C, illustrated is a schematic illustration of the determined measurement point 600, in accordance with an embodiment of the present disclosure. Specifically, the measurement point 600 is determined using X-directional edges of a person (such as the person 102) and summed area tables to generate sums of values inside rectangular areas 612 and 614 on the edge representation 400. For example, the rectangular areas 612 to be added and the rectangular area 614 to be subtracted are represented distinctly to distinguish therebetween.

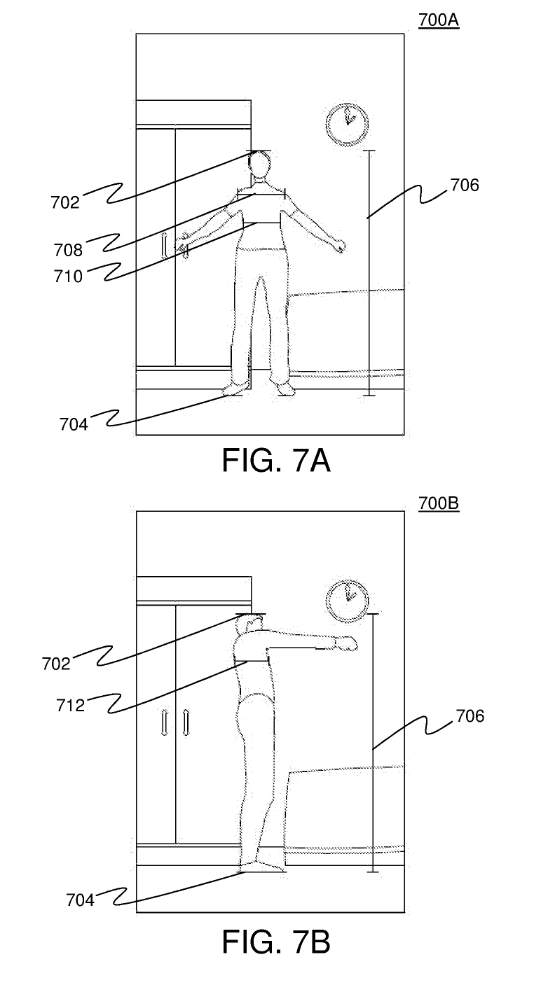

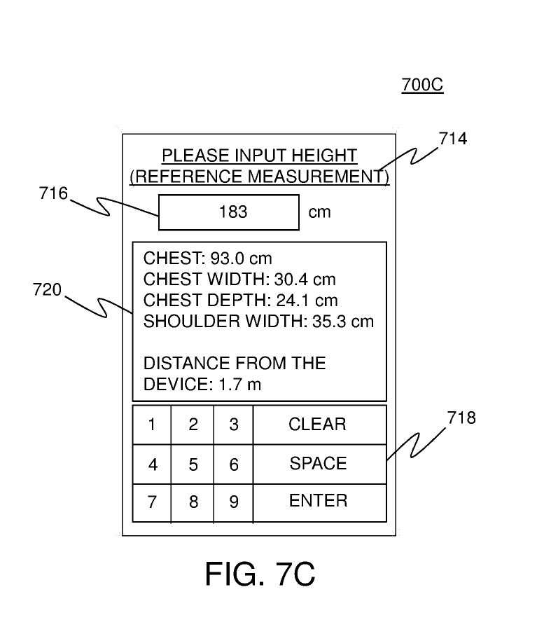

Referring to FIG. 7A, illustrated is a user interface 700A for displaying the determined anthropometric measurements of the person 102 using the front view image of the person 102 (received using the user interface 20013 of FIG. 2), in accordance with an embodiment of the present disclosure. As shown, extremities 702 representing top of head of the person 102, and 704 representing tip of feet of the person 102 are displayed on the user interface 700A. A line 706 is displayed to indicate length between the extremities 702 and 704, thereby representing height of the person 102. Further, lines 708 and 710 displayed on the user interface represent determined measurements between measurement points. In an example the line 708 represents a measurement of chest width. In another example, the line 710 represents a measurement of waist length.

Referring to FIG. 7B, illustrated is a user interface 70013 for displaying the determined anthropometric measurements of the person 102 using the side view image of the person 102 (received using the user interface 200C of FIG. 2), in accordance with an embodiment of the present disclosure. As shown, the extremities 702 representing top of head of the person 102, and 704 representing tip of feet of the person 102 are displayed on the user interface 700A. The line 706 is displayed to indicate length between the extremities 702 and 704, thereby representing height of the person 102. Further, line 712 displayed on the user interface represents a determined measurement between measurement points. In an example the line 712 represents a measurement of chest depth.

Referring to FIG. 7C, illustrated is a user interface 700C for displaying the determined anthropometric measurements of the person 102 using received at least two images of the person 102 (such as the front and side views of the person received using the user interfaces 20013 and 200C respectively). As shown, an instruction 714 (such as ‘Please input height (Reference Measurement)’) is displayed on the user interface 700C to receive the reference measurement as input from the person 102. The person 102 inputs his height in a box 716 on the user interface 700C, using a keypad 718. The determined anthropometric measurements of the person 102 are displayed on a region 720, of the user interface 700C as shown. In an example, distance of the person 102 from the device 104 is also displayed on the user interface 700C (as shown on the region 720).

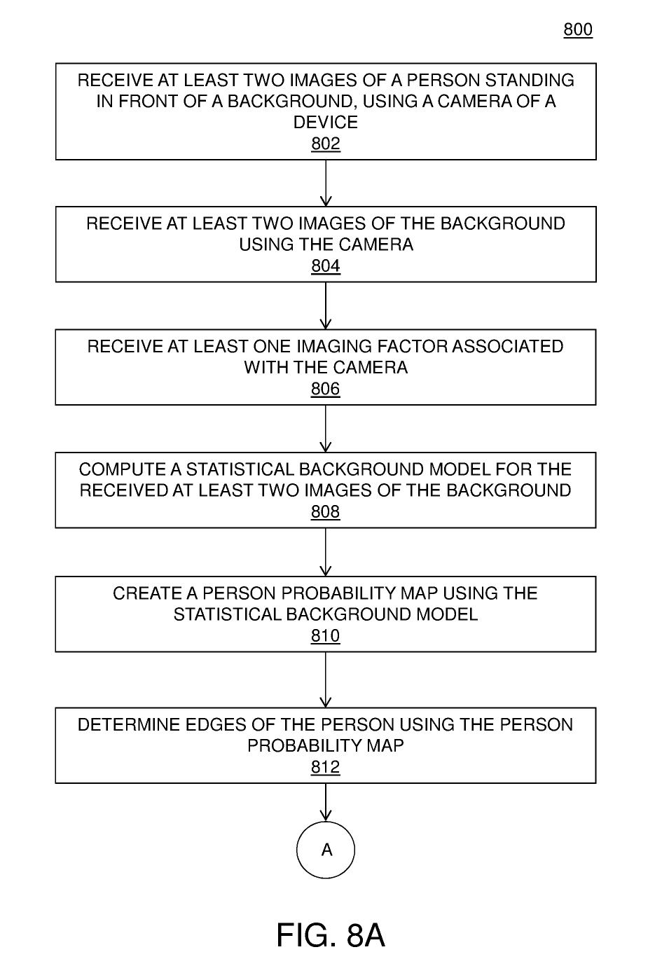

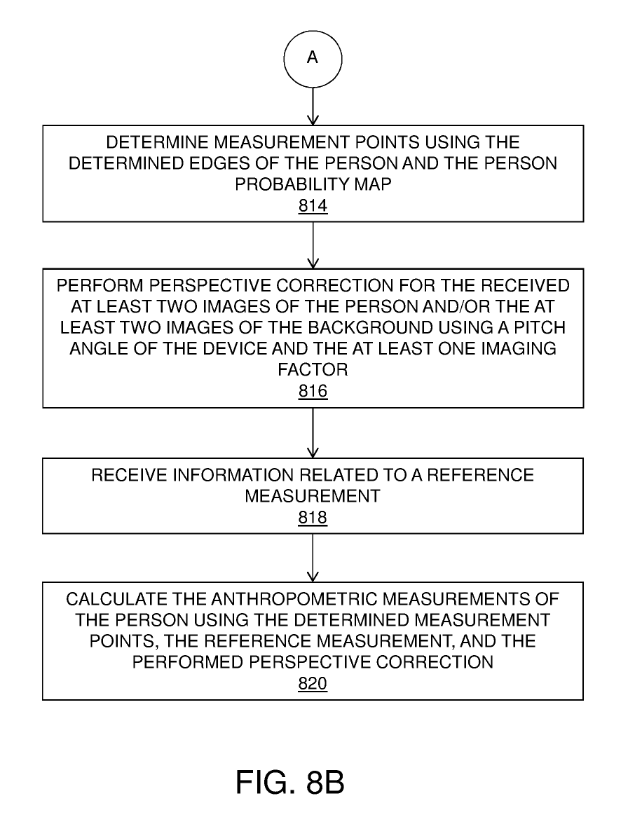

Referring to FIGS. 8A-8B, illustrated are steps of a method 800 for determining anthropometric measurements of a person, in accordance with an embodiment of the present disclosure. At step 802, at least two images of the person standing in front of a background are received using a camera of a device. At step 804, at least two images of the background are received using the camera. At step 806, at least one imaging factor associated with the camera is received. At step 808, a statistical background model for the received at least two images of the background is computed. At step 810, a person probability map is created using the statistical background model. At step 812, edges of the person are determined using the person probability map. At step 814, measurement points are determined using the determined edges of the person and the person probability map. At step 816, perspective correction is performed for the received at least two images of the person and/or the at least two images of the background using a pitch angle of the device and the at least one imaging factor. At step 818, information related to a reference measurement is received. At step 820, the anthropometric measurements of the person are calculated using the determined measurement points, the reference measurement, and the performed perspective correction.

The steps 802 to 820 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for determining anthropometric measurements of a person, the method comprising:
receiving at least two images of the person standing in front of a background, using a camera of a device;
receiving at least two images of the background using the camera;
receiving at least one imaging factor associated with the camera;
computing a statistical background model for the received at least two images of the background;
creating a person probability map using the statistical background model;
determining edges of the person using the person probability map;
determining measurement points using the determined edges of the person and the person probability map;
performing perspective correction for the received at least two images of the person and/or the at least two images of the background using a pitch angle of the device and the at least one imaging factor;
receiving information related to a reference measurement; and
calculating the anthropometric measurements of the person using the determined measurement points, the reference measurement, and the performed perspective correction.

2. A method according to claim 1, wherein receiving at least two images of the person standing in front of a background comprises:
displaying a person silhouette on a screen of the device;
capturing the at least two images of the person, wherein the person conforms to the silhouette; and
indicating capture of each image of the at least two images of the person.

3. A method according to claim 1, wherein the at least two images of the person comprise at least a front view of the person, and a side view of the person.

4. A method according to claim 1, wherein receiving at least two images of the background comprises:
capturing the at least two images of the background; and
indicating capture of the at least two images of the background.

5. A method according to claim 1, wherein the method further comprises displaying imaging instructions related to placement of the device and posture of the person, on the device.

6. A method according to claim 4, wherein receiving the at least two images of the background is interrupted upon detecting presence of the person in field of view of the camera.

7. A method according to claim 1, wherein the at least one imaging factor is at least one of distance between device and the person, field of view of the camera, focal length of the camera, and specifications of image sensor of the camera.

8. A method according to claim 1, wherein computing a statistical background model comprises:
calculating lightness (a), relative red colour (r), and relative green colour (g) for all pixels in each of the received at least two images of the background;
calculating average lightness (ā), average relative red colour (r̅), and average relative green colour (g̅) for all pixels;
calculating variance of lightness (σₐ), variance of relative red colour (σᵣ), and variance of relative green colour (σ_{g}) for all pixels;
calculating averages of calculated variances of lightness (σ̅ₐ), relative red colour (σ̅ᵣ), and relative green colour (σ̅_{g}); and
truncating the variances of lightness (σₐ), relative red colour (σᵣ), and relative green colour (σ_{g}) for all pixels in proportion to the averages of calculated variances.

9. A method according to claim 1, wherein creating a person probability map using the statistical background model comprises:
calculating lightness (aₚₑᵣₛₒₙ), relative red colour (rₚₑᵣₛₒₙ), and relative green colour (gₚₑᵣₛₒₙ) for all pixels in each of the received at least two images of the person;
calculating lightness change (Δa) and colour change (ΔColour) by comparing the calculated lightness (aₚₑᵣₛₒₙ), relative red colour (rₚₑᵣₛₒₙ), and relative green colour (gₚₑᵣₛₒₙ) with the statistical background model;
defining at least one discriminant function based on the calculated colour change;
calculating probability of each pixel in each of the received at least two images of the person to belong to the person (Pₚₑᵣₛₒₙ), depending on the discriminant functions, lightness change (Δa) and colour change (ΔColour); and
displaying the calculated probabilities in a RGB colour channel.

10. A method according to claim 1, wherein determining edges of the person using the person probability map comprises:
determining X and Y directional gradients (Gx and Gy) of the received at least two images of the person, the received at least two images of the background, and the person probability map using Sobel operators;
calculating preliminary edges of the person using the X and Y directional gradients of the received at least two images of the person;
calculating background edges in at least one image of the received at least two images of the background; and
computing the edges of the person (Gperson) from the calculated preliminary edges of the person.

11. A method according to claim 10, wherein computing the edges of the person (Gperson) from the calculated preliminary edges of the person comprises:
retaining the calculated preliminary edges of the person if same directional edges are present in the person probability map; and
reducing the calculated preliminary edges of the person if the same directional edge is present within a region of high probability of the person.

12. A method according to claim 10, further comprising computing X and Y directional components (Gxₚₑᵣₛₒₙ and Gyₚₑᵣₛₒₙ) of the edges of the person.

13. A method according to claim 1, wherein determining measurement points using the determined edges of the person comprises:
calculating Y-projection sum (Pproj_{Y}) of the calculated probability of each pixel in each of the received at least two images of the person to belong to a person;
estimating center of body of the person and width of the body of the person using a first mask function and the calculated Y-projection sum (Pproj_{Y});
estimating body depth of the person using a second mask function and the calculated Y-projection sum (Pproj_{Y});
calculating summed area tables using the person probability map and X and Y directional components of the edges of the person (Gxₚₑᵣₛₒₙ and Gyₚₑᵣₛₒₙ);
locating extremities of the body of the person; and
detecting measurement points using the located extremities, rectangle based features, and the determined edges of the person.

14. A method according to claim 1, wherein the method further comprises providing setup instructions to the person, on the device.

15. A method according to claim 14, wherein the setup instructions comprise information related to at least one of clothing requirements for the person, posture of the person, specifications for the background, and placement of the device.

16. A method according to claim 1, wherein the method further comprises normalizing the received at least two images of the person standing in front of the background relative to one image of the received at least two images of the background.

17. A method according to claim 1, wherein the method further comprises storing the determined anthropometric measurements of the person.

18. A method according to claim 1, wherein the method further comprises making a clothing size suggestion based on the determined anthropometric measurements of the person.
